(19) United States
(12) Patent Application Publication
(10) Pub. No.: US 2026/0330697 A1
(43) Pub. Date: Oct. 22, 2026

(54) PIXEL PREDICTION-BASED, SELECTIVE COMPRESSION OF IMAGE

(71) Applicant: INTERNATIONAL BUSINESS MACHINES CORPORATION, Armonk, NY (US)

(72) Inventors: Sathya SANTHAR, Ramapuram (IN); Sarbajit Kumar RAKSHIT, Kolkata (IN); Sridevi KANNAN, Katupakkam (IN); Samuel Mathew JAWAHARLAL, Chennai (IN)

(21) Appl. No.: 19/185,343

(22) Filed: Apr. 22, 2025

(51) Int. Cl. G06T 9/00

(52) U.S. Cl. CPC G06T 9/002

(57) ABSTRACT

A pixel prediction-based process is provided which includes executing a generative adversarial network (GAN)-based model on an image to select pixels of the image with valid proxy pixels to facilitate image compression. For a masked pixel of the image, executing the model includes generating a predicted pixel based on surrounding pixels of the masked pixel in a process window iteration over the image, and selecting the predicted pixel as a valid proxy pixel where a similarity comparison of the predicted pixel to a corresponding original pixel exceeds a similarity threshold. Further, the process includes selectively compressing the image to produce a selectively compressed image, where the selectively compressing includes masking, at least in part, the selected pixels of the image in producing the selectively compressed image, and where the selectively compressed image can be uncompressed, at least in part, by reconstructing the predicted pixels for the selected pixels.

### BACKGROUND

One or more aspects relate, in general, to enhancing image processing within a computing environment, and more particularly, to pixel prediction-based, selective compression of an image to facilitate digital image transmission and reconstruction.

Generative adversarial networks are a recent innovation in machine learning and represent an approach towards generative modeling using deep learning methods, such as convolutional neural networks. Generative adversarial networks present a way of training a generative model by framing a problem as a supervised learning problem with two sub-models: a generator model that is trained to generate new examples, and a discriminator model that tries to classify examples as either real (from the domain) or fake (generated). The two models are trained together in a zero-sum game, adversarial, until the discriminator model is fooled about half the time, meaning that the generator model is generating plausible examples.

### SUMMARY

Shortcomings of the prior art are overcome, and additional advantages are provided herein through the provision of a method which includes executing a trained generative adversarial network (GAN)-based model on an image to select pixels of the image with valid proxy pixels being generated by the GAN-based model to facilitate image compression. For a masked pixel of the image, executing the GAN-based model includes generating a predicted pixel based on surrounding pixels of the masked pixel in a process window iteration over the image, and selecting the predicted pixel as a valid proxy pixel where a similarity comparison of the predicted pixel to a corresponding original pixel exceeds a pixel content similarity threshold. Further, the method includes selectively compressing the image to produce a selectively compressed image, where the selectively compressing includes masking, at least in part, the selected pixels of the image in producing the selectively compressed image, and where the selectively compressed image can be uncompressed by reconstructing the predicted pixels for the selected pixels of the image.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the disclosed inventive aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2A-2D depict one embodiment of a computer program product with image pixel process code, in accordance with one or more aspects of the present disclosure;

FIGS. 3A-3B depict one embodiment of an image pixel process workflow, in accordance with one or more aspects of the present disclosure;

FIG. 4 is a further example of a computing environment to include and/or use one or more aspects of the present disclosure;

FIG. 5 depicts one example of machine learning model training, in accordance with one or more aspects of the present disclosure;

FIG. 6 is a further example of a computing environment to include and/or use one or more aspects of the present disclosure;

FIG. 7 depicts another embodiment of an image pixel process workflow, in accordance with one or more aspects of the present disclosure;

FIGS. 8A-8C depict one embodiment of image pixel pre-processing, in accordance with one or more aspects of the present disclosure;

FIGS. 9A & 9B depict one embodiment trained generative adversarial network (GAN)-based model processing to generate a predicted pixel based on surrounding pixels (FIG. 9A) and to select a predicted pixel as a valid proxy pixel (FIG. 9B) pursuant to the pixel prediction-based, selective compression process, in accordance with one or more aspects of the present disclosure; and

FIG. 10 depicts another embodiment of an image pixel process workflow, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known software, systems, devices, processing techniques, tools, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, tools, engines, etc. One or more aspects of an illustrative embodiment can be implemented in software, hardware, or a combination thereof.

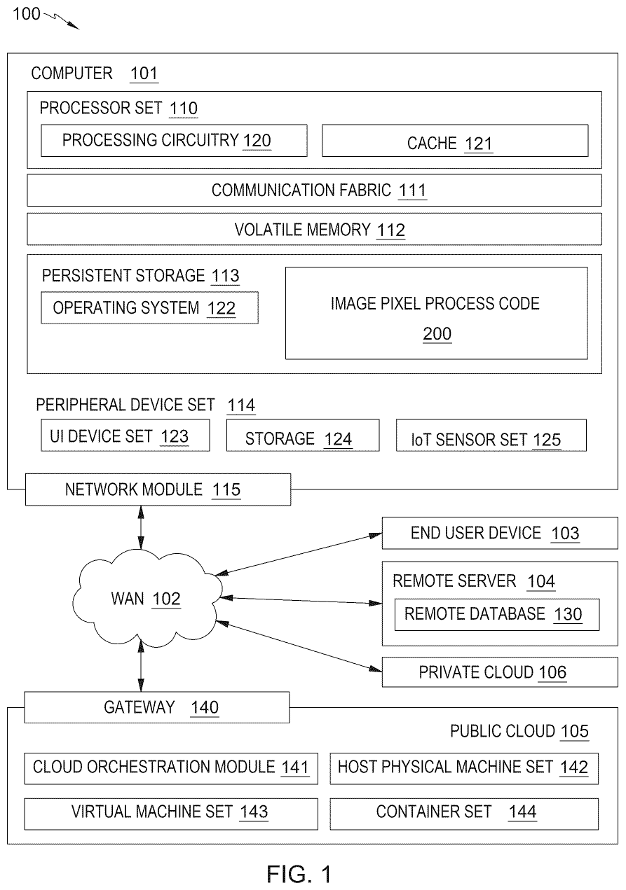

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as code, or one or more programs, are depicted in FIG. 1, including operating system 122 and image pixel process code 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1, computing environment 100 contains an example of an environment for the execution of at least some of the computer code involved in performing the inventive methods, such as image pixel process code 200. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in image pixel process code 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

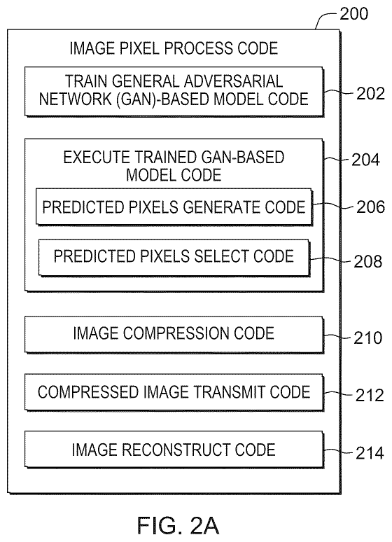

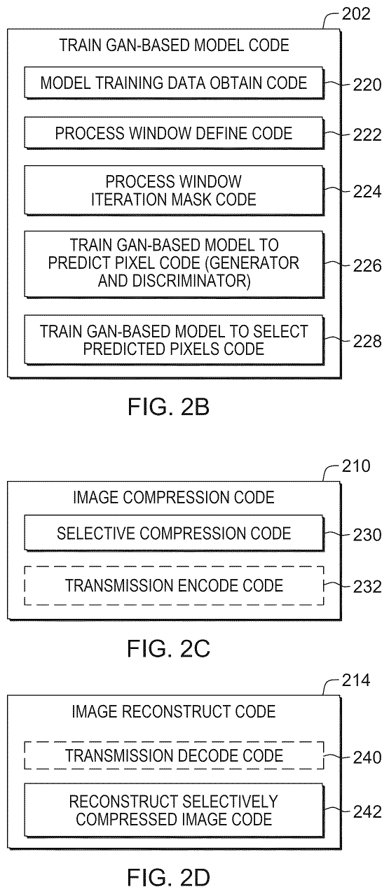

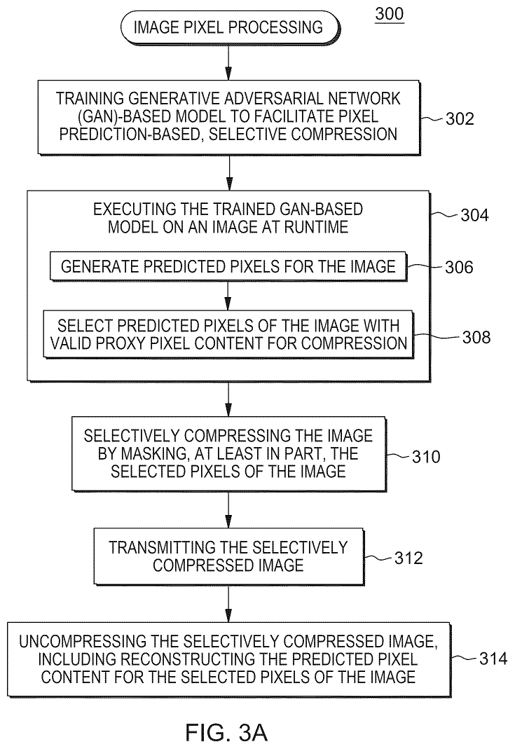

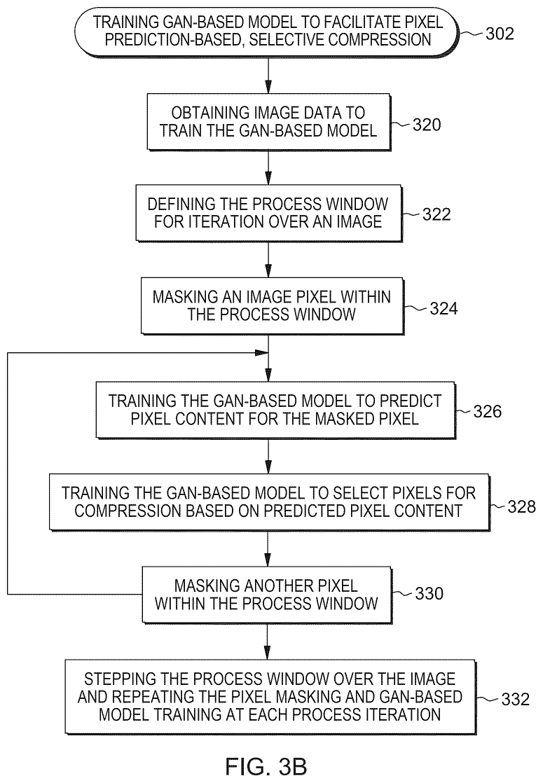

By way of example, embodiments of the image pixel process code and image pixel process workflow are described initially with reference to FIGS. 2A-3B. FIGS. 2A-2D depict embodiments of image pixel process code 200 that includes code or instructions (e.g., of one or more artificial intelligence systems) to perform image pixel processing, in accordance with one or more aspects of the present disclosure, and FIGS. 3A-3B depict an embodiment of an image pixel process workflow, in accordance with one or more aspects of present disclosure.

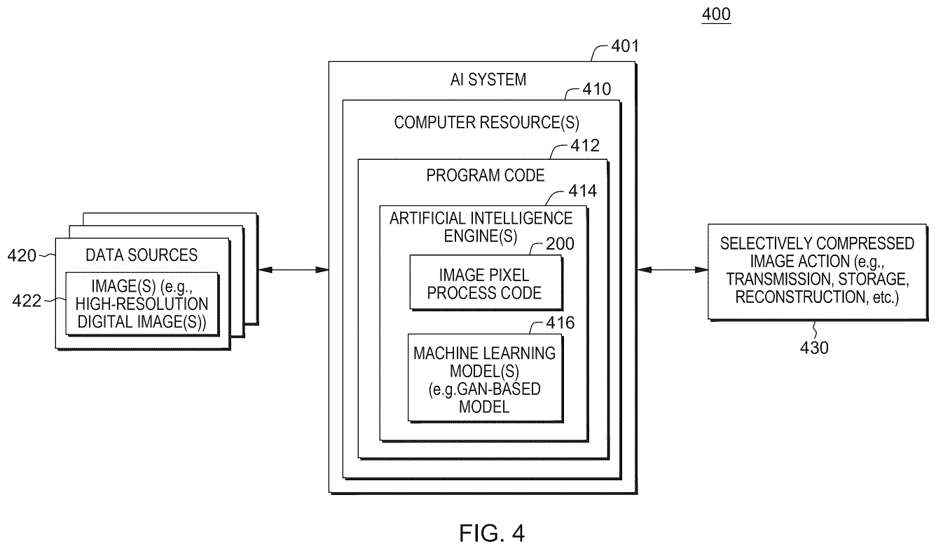

Referring to FIGS. 1-2D, image pixel process code 200 includes, in one example, various code or sub-modules used to perform processing, in accordance with one or more aspects of present disclosure. The sub-modules are, e.g., computer-readable program code (e.g., instructions) in computer-readable media (e.g. persistent storage 113, such as a disk) and/or cache (e.g., cache 121) as examples). The computer-readable media can be part of one or more computer program products and can be executed by and/or using one or more computers, such as computer(s) 101 (FIG. 1), and/or one or more artificial intelligence (AI) systems (e.g., artificial intelligence system 401, 401′ (FIGS. 4 & 6)), etc. ; one or more processor sets 110 (FIG. 1); processors, such as one or more processors of processor set 110; and/or processing circuitry, such as processing circuitry of processor set 110, etc.

As noted, FIG. 2A-2D depict embodiments of image pixel process code 200 which, in one or more implementations, facilitates pixel prediction-based, selective image compression, in accordance with one or more aspects of present disclosure. As depicted in FIG. 2A, in one or more embodiments, image pixel process code 200 includes train generative adversarial network (GAN)-based model code 202 to, in one or more embodiments, train the GAN-based model to identify pixels of a digital image for selective compression. One embodiment of train GAN-based model code 202 is depicted in FIG. 2B, as including model training data obtain code 220 to obtain, for instance, digital image data, such as high resolution digital image data, for use as training data to train the GAN-based machine learning model; and process window define code 222 to facilitate defining a process window (e.g., kernel, filter, sliding window, etc.) of size N×N, where N×N can be any of a variety of process window sizes including, for instance, 2×2, 3×3, 4×4, etc., selected for a particular image, or type of image, based for instance, on content, such as the number of objects in the image or in a type of image being processed. In addition, in one or more embodiments, a stride value can also be defined, or predefined, for moving (e.g., sliding, stepping, placing, etc.) the process window across an image (or image window) so that pixels of the image can be skipped or included in the GAN-based model processing, as desired for a particular application. In one or more embodiments, train GAN-based model code 202 includes pixel mask per process window iteration code 224 to mask, for instance, one pixel of the image within a processing iteration as hidden. Note that, in one or more embodiments, with each process window iteration, a different pixel of the image within the process window is masked, such as at a particular overlay position on the image, with the processing being repeated for different overlay positions of the process window over the image (or image window). Note also in this regard, that the process window is moved across the image or image window in a specified direction (e.g., forward direction) with the processing being repeated at multiple different overlay positions over the image.

In one or more embodiments, train GAN-based model code 202 further includes train GAN-based model to predict pixel code 226 to facilitate training the generator and discriminator of the GAN-based model, such as disclosed herein. In one or more embodiments, a different pixel within the image window at each process iteration is hidden (e.g., masked) so that the GAN-based model is trained to predict the hidden pixel based on its surrounding pixels, such as within the process window, with the process iterations continuing at different process window locations over the image (or image window). In addition, train GAN-based model 202 includes, in one or more embodiments, train GAN-based model to select predicted pixels code 228 to select a predicted pixel as a valid proxy pixel where a similarity comparison of the predicted pixel content to the corresponding original pixel content exceeds a pixel count similarity threshold. In one or more embodiments, train GAN-based model to select predicted pixels code 228 can include, for instance, predefined pixel content similarity threshold code to facilitate training the GAN-based machine learning model to determine a pixel content similarity threshold for a particular application of the pixel prediction-based, selective compression process, and/or for a particular image content or type of image to be processed. Additionally, train GAN-based model to select predicted pixels code 228 can include, for instance: pixel content similarity score determine code to train the GAN-based machine learning model to determine content similarity between the predicted pixel and the correspondence original pixel; similarity score to threshold compare code to compare the pixel content similarity score to the pixel content similarity threshold; and select predicted pixels code to select one or more predicted pixels as valid proxy pixels where the comparison of the predicted pixels to the corresponding original pixels exceeds the defined pixel content similarity threshold.

As illustrated in FIG. 2A, in one or more embodiments, image pixel process code 200 further includes execute trained GAN-based model code 204 which includes, in one or more embodiments, code to initiate executing, by a computing environment (e.g., computer, artificial intelligence system, processor, etc.), the pretrained generative adversarial network (GAN)-based model on a particular image to predict pixels of the image with valid proxy pixels. Note that the predicting occurs as the image (e.g., a large, high-resolution image, media file, video feed, etc.) is passed through the trained GAN-based model, and that the image can be a single image or a series of images (such as a series of image frames of a video file). In one or more embodiments, execute trained GAN-based model on image code 204 includes predicted pixels generate code 206 to, for instance, generate a predicted pixel based on surrounding pixels of a masked pixel in a process window iteration over the image as disclosed herein, and predicted pixels select code 208 to select a predicted pixel as a valid proxy pixel where a comparison of the predicted pixel to the corresponding original pixel exceeds the predefined pixel content similarity threshold. Note that, in one or more embodiments, the process can include setting a proxy pixel flag as ‘Yes’ if the pixel similarity score exceeds the threshold value, in which case the given pixel is eligible to be compressed (e.g., by masking). In contrast, the proxy pixel flag can be set ‘No’ if the pixel content similarity flag falls below the threshold value, in which case the given pixel is not eligible to be compressed.

As depicted in FIG. 2A, in one or more embodiments, image pixel process code 200 further includes image compression code 210 to, for instance, selectively compress the image to produce a selectively compressed image. One embodiment of image compression code 210 is depicted in FIG. 2C, where image compression code 210 includes selected pixels mask code 230 to mask, at least in part, the selected pixels of the image which have corresponding valid proxy pixels. Masking, at least in part, the selected pixels of the image can include, in one or more embodiments, blocking as compressed latent data the selected pixels of the image to facilitate producing the selectively compressed image, or substituting a default value for each selected pixel to facilitate producing the selectively compressed image. In one or more embodiments, selected pixel masked code 230 masks, at least in part, only the selected pixels of the image in producing the selectively compressed image. As illustrated, in one or more embodiments, image compression code 210 further optionally includes transmission encode code 232 to further encode for transmission, for instance, using an available image compression network model, the selectively compressed image, where the masking of the selected pixels advantageously reduces the amount of image data to compressed, encoded and/or transmitted, and thereby facilitates processing and communication or transfer of the image, for instance, across one or more networks from a sender (e.g., sender system, sender device, sender component, etc.) to a receiver (e.g., receiver system, receiver device, receiver component, etc.).

As illustrated in FIG. 2A, in one or more embodiments, image pixel process code 200 further includes compressed image transmit code 212 to transmit the compressed image from a sender (e.g., sender system, device or component) to a receiver (e.g., receiver system, device or component). Note that in this regard the sender and receiver can each be one or more computer systems, electronic devices, electronic components, etc., and that the network can be, in one or more embodiments, an internal network within a computing environment, and/or an external network between one or more computing environments, computer systems, etc. Many variations are possible.

In one or more embodiments, image pixel process code 200 is, at least in part, separately resident on, or accessed by, both the sender and the receiver, and in one or more embodiments, image pixel process code 200 further includes image reconstruct code 214, to reconstruct the received image, such as at the receiver. As illustrated in FIG. 2D, in one embodiment, image reconstruct code 214 includes, for instance, transmission decode code 240 to decode the received compressed image, such as where a network compression model was also employed at the sender (or between the sender and the receiver). In addition, in one or more embodiments, image reconstruct code 214 includes reconstruct selectively compressed code 242, to reconstruct predicted pixels for the masked pixels of the selectively compressed image. In one or more embodiments, reconstructing the masked pixels can include reversing the direction of GAN-based model processing for the masked pixels. In one embodiment, reversing the direction of processing includes proceeding in a reverse direction over the received image to the process direction used at the sender for identifying the selected pixels for masking. In this manner, a more accurate version of the uncompressed and reconstructed high-resolution image is regenerated at the receiver, for instance, for display, storage, further processing, etc.

Note that although various code or sub-modules are described herein, image pixel process code, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the image pixel process code is used, in accordance with one or more aspects of the present disclosure, to perform image pixel processing. By way of example, FIGS. 3A-3B depict one embodiment of image pixel processing 300, such as disclosed herein. The process is executed, in one or more embodiments, by one or more computers (e.g., computer 101 (FIG. 1), one or more artificial intelligence (AI) systems (e.g., artificial intelligence systems 401, 401′ (FIGS. 4 & 6, etc.)), and/or one or more processor sets, such as a processor or processing circuitry (e.g., of processor set 110 of FIG. 1). In one example, code or instructions implementing the processing, are part of a code or module, such as image pixel process code 200 of FIGS. 1-2D. In other examples, the code can be included in one or more other modules and/or one or more other sub-modules of the one or more modules. Various options are available.

In one or more embodiments, image pixel processing 300 (FIG. 3) executes on one or more computers (e.g., computer 101 of FIG. 1, artificial intelligence (AI) systems 401, 401′ (FIGS. 4 & 6), and/or one or more processor sets (e.g., processor set 110 of FIG. 1, such as a processor or processing circuitry of the processor set)) and performs processing such as disclosed herein, which includes, in one or more embodiments, training a generative adversarial network (GAN)-based model (or GAN-based machine learning model) to facilitate pixel prediction-based, selective compression 302. As illustrated in FIG. 3B, in one or more embodiments, training GAN-based model to facilitate pixel prediction-based selective compression includes obtaining image data to train the GAN-based model 320, where the image data includes, in one ore more embodiments, multiple digital images input (e.g., received, retrieved, etc.) as a training data set for training the model. As an example, the images can be, or be representative of, high-resolution digital images or video which needs to be compressed and transmitted to a receiver of a computing environment with enhanced efficiency and image quality to existing processes. As described herein, images are pre-processed before passing to the GAN-based model core. The training of the GAN-based model processing includes defining a process window for sliding over an image 322. For instance, the process window (e.g., kernel, filter, sliding window, etc.) is defined as a N×N sized window that is to be slid over the input window of the image, such as in a forward direction (e.g., left to right, top to bottom), at a specified stride value. In one or more embodiments, the process window can be a 2×2, 3×3, 4×4, etc., kernel that is slid over the input window of the image. The stride value is defined to direct how the process window is stepped across the image, so that pixels can be skipped or included during the slide process, as desired for a particular application. In one or more embodiments, training the GAN-based model to facilitate pixel prediction-based selective compression 302, further includes masking an image pixel within a process window iteration (or process cycle) 324 to facilitate training the GAN-based model to generate a predicted pixel for the masked pixel based on known content of surrounding pixels to the masked pixel, such as in the process window portion of the image. In one or more embodiments, once each pixel within the process window has been processed, the training process repeats by, in part, sliding the process window to a next position on the image to facilitate training the generator network and the discriminator network of the generative adversarial network model on the image over many process iterations or cycles. During training, the generator network performs the task of pixel prediction, with the pixel generation being based on the surrounding pixels of the masked pixel, and the discriminator network does the task of finding whether the generated or predicted pixel is a real (or valid pixel) or a fake pixel (in terms of quality), and back propagates the determined loss.

For example, in one or more embodiments, training the GAN-based model to facilitate pixel prediction-based, selective compression 302 encompasses a repeating loop which includes training the GAN-based model to predict pixel content for the masked pixel 326. As noted, training the GAN-based model to generate the predicted pixel for the masked pixel is based on known content of the surrounding pixels to the masked pixel, such as in the process window portion of the image.

In one or more embodiments, training the GAN-based model to facilitate pixel prediction-based, selective compression 302, further includes training the GAN-based model to select pixels for compression based on predicted pixel content 328. For instance, in one or more embodiments, the GAN-based model further includes a predicted pixel select model (or classifier model), which is trained to select a predicted pixel as a valid proxy pixel where a comparison of the predicted pixel content to the corresponding original pixel content (as determined, for instance using image processing similarity comparison) exceeds a specified pixel content similarity threshold. As noted, the similarity threshold can be a tunable parameter and can be predefined in the model based on model training. In one or more embodiments, training the GAN-based model includes training the GAN-based model to select predicted pixels using respective generated pixel content similarity scores (in terms of content). In one or more embodiments, a pixel content similarity score is determined or calculated by similarity comparison processing the predicted pixel content and the corresponding original pixel content of the image to determine whether the predicted pixel is a valid proxy pixel for the original pixel of the image. In this manner, the GAN-based model is trained to select the best predicted pixels as valid proxy pixels for use in the selective compression process. For instance, in one or more embodiments, the comparing means that at a given timestep (or iteration, cycle, etc.) when the GAN-based model predicts the predicted pixel of the image has less loss value and is more similar to the original pixel, then the pixel content similarity score is set higher. In one or more embodiments, at any timestep where the GAN-based model is unable to predict the missing pixel of the input image (i.e., where the prediction has more loss value and is less similar to the original pixel), then the pixel content similarity score is specified to be lower. In one or more embodiments, where the pixel similarity score exceeds the pixel content similarity threshold value, then the corresponding pixel is eligible to be compressed (or masked), and is flagged, for instance, as “proxy pixel: Yes”. Conversely, if the pixel content similarity score is below the threshold value, then the predicted pixel is not eligible to be compressed (or masked), and is flagged as “proxy pixel: No”. After the full process of training the GAN-based selector (or classifier) model with multiple images, the best reconstructed pixels can be identified overall and marked as “proxy pixel: Yes”. The pixels of the “proxy pixel: Yes” category are the pixels that can be selectively compressed by masking, such as during a validation and testing phase of the model training, and/or during runtime of the GAN-based model. Note in this regard that selective compression of the best pixels (that is, the predicted pixels selected as valid proxy pixels for compression) leads to better transmission and reconstruction processing results, which facilitates the compression/decompression and transmission processes.

As illustrated in FIG. 3B, in one or more embodiments, training GAN-based model to facilitate pixel prediction-based, selective compression 302 further includes masking another pixel within the process window 330 and looping back to repeat the training of the GAN-based model to predict pixel content for the next masked pixel 326, and the training of the GAN-based model to select pixels for compression based on the predicted pixel content 328. After one or more, or all, of the pixels of the process window have been considered at one location over the image window, the process window is stepped to a new location over the image, and the pixel masking and GAN-based model training is repeated. Note that, in one or more embodiments, the training process of FIG. 3B is repeated over multiple training image datasets, as desired for a particular application.

As depicted in FIG. 3A, in one or more embodiments, image pixel processing 300 further includes executing the trained GAN-based model on (or over) an image at runtime 304, which can include generating predicted pixels for the image 306 and selecting the predicted pixels of the image with valid proxy pixels 308. For instance, in one or more embodiments, the executing includes executing the trained GAN-based model on an image to select pixels of the image with valid proxy pixels generated by the model, where for a masked pixel of the image, executing the trained GAN-based model includes generating a predicted pixel based on the surrounding pixels of the masked pixel in a process window iteration over the image, and selecting the predicted pixel as a valid proxy pixel occurs where the similarity comparison of the predicted pixel to the corresponding original (i.e., unmasked) pixel exceeds the specified pixel content similarity threshold. The process is repeated over a plurality of iterations (e.g., many iterations or cycles) of the process window on the image. For example, in one or more embodiments, the process is repeated for each pixel within the process window at a particular location of the image, and then repeated across multiple different locations of the process window over the image. Note that, in one or more embodiments, the size of the process window (N×N) can be predefined for a particular image or image type based, for instance, on the number of objects in the image, and/or based on other factors representative of consistency or similarity of pixels across the image. In one or more embodiments, executing the trained GAN-based model on the image allows the model to predict the valid proxy pixels for any image, such as in a large size, high-resolution image, when passed through (or processed by) the GAN-based model. For instance, in one or more embodiments, the model identifies and flags the optimum pixels in an image as “proxy pixels: Yes” to facilitate compressing or masking some, or all, of the identified pixels during selectively compressing of the image.

As noted, and as illustrated in FIG. 3A, image pixel processing 300 includes compressing the image by masking, at least in part, the selected pixels of the image in producing a selectively compressed image 310. This produces a compression of only selected pixels of the image, rather than fully and/or randomly compressing the image pixels, which can result in poorer transmission and/or reconstruction of the original image with greater processing overhead. By partially compressing or masking the selected pixels as disclosed, a seamless and enhanced compression, transmission and decompression process is provided. For instance, the partial and selective pixel compression, or masking, leads to better transmission speed and better quality of images during the reconstruction process, since the selected pixels correspond to the predicted pixels with the best valid proxy pixels (that is, the highest similarity score to the original pixel, such as those scores above the tunable threshold). In one or more embodiments, compressing the image can further include, for instance, applying one or more transmission compression models, or encode models, to the image with the selectively masked pixels, resulting in a selectively compressed and encoded image, which can then be transmitted to a receiver (e.g., a receiver system, device, component, etc.) 312. In one or more embodiments, image pixel processing 300 further includes uncompressing the received image at the receiver, including reconstructing the predicted pixels for the masked pixels of the image 314. In one or more embodiments, the trained GAN-based model is accessed by, or implemented at, the receiver (e.g., receiver system, device, component, etc.) to reconstruct the respective, predicted pixels as part of the decompression process, where the reconstructing is, in one embodiment, in a reverse (or backward) direction to the original image processing direction at the sender, since the later masked pixels of the image can be needed or helpful to reconstructing the prior masked pixels. Advantageously, the original, high-resolution image is thereby more closely generated or regenerated at the receiver by selectively compressing only the pixels which can be regenerated with high accuracy based on the GAN-based model. The selective compression of the best predicted pixels leads to better transmission and reconstruction processes.

By way of further example, FIG. 4 depicts another embodiment of a computing environment 400, which can incorporate, use or implement, one or more aspects of an embodiment of the present disclosure. In one or more embodiments, computing environment 400 is implemented as part of, or includes, a computing environment such as computing environment 100 described above in connection with FIG. 1. In one or more implementations, computing environment 400 includes an artificial intelligence (AI) system 401 with one or more computer resources 410, such as one or more computers 101 of FIG. 1, connected across one or more networks 405 to receive (e.g., obtain, access, etc.) data from one or more data sources 420 (or digital image sources). The data can be, or include, one or more images 422, for instance, one or more high resolution digital images. Note that although depicted in FIG. 4 as part of a separate data source (e.g., as part of a remote image capture system), in one or more other embodiments, images 422 can be associated with, located within, and/or generated by AI system 401.

In embodiments, the one or more computer resources 410 of AI system 401 execute program code 412 that runs or implements, for instance, one or more artificial intelligence engines 414 that include one or more aspects of image pixel process code 200 (FIGS. 2A-2D) and/or image pixel processing 300 (FIG. 3), such as disclosed herein. In one or more embodiments, image pixel process code 200 includes, utilizes and/or trains one or more machine learning models 416, which can be part of image pixel process code 200 or accessed by image pixel process code 200. In one or more embodiments, machine learning models 416 include, for instance, one or more trained generative adversarial network (GAN)-based machine learning models, which when executed on or over an image (i.e., a digital image) function to select pixels of the image flagged with valid proxy pixels generated by the GAN-based model to facilitate image compression. As noted herein, in one or more embodiments, executing the trained GAN-based model includes, for a masked pixel of the image, generating a predicted pixel based on surrounding pixels of the masked pixel in a process window iteration over the image, and selecting the predicted pixel as a valid proxy pixel where a similarity comparison of the predicted pixel to the corresponding original pixel (i.e., the original pixel content) exceeds a pixel count similarity threshold predefined for the trained GAN-based model and/or for the particular image processing application. Note that, in one or more embodiments, artificial intelligence engine 414, or another system, facilitates training one or more machine learning model(s) 416, such as to perform one or more aspects of the image pixel processing disclosed herein. Further, in one or more embodiments, artificial intelligence system 401, and in particular, artificial intelligence engine(s) 414, executes one or more machine learning models 416, such as described herein, on one or more images to select pixels of the one or more images with valid proxy pixels (generated by the generative adversarial network (GAN)-based model) to facilitate image compression.

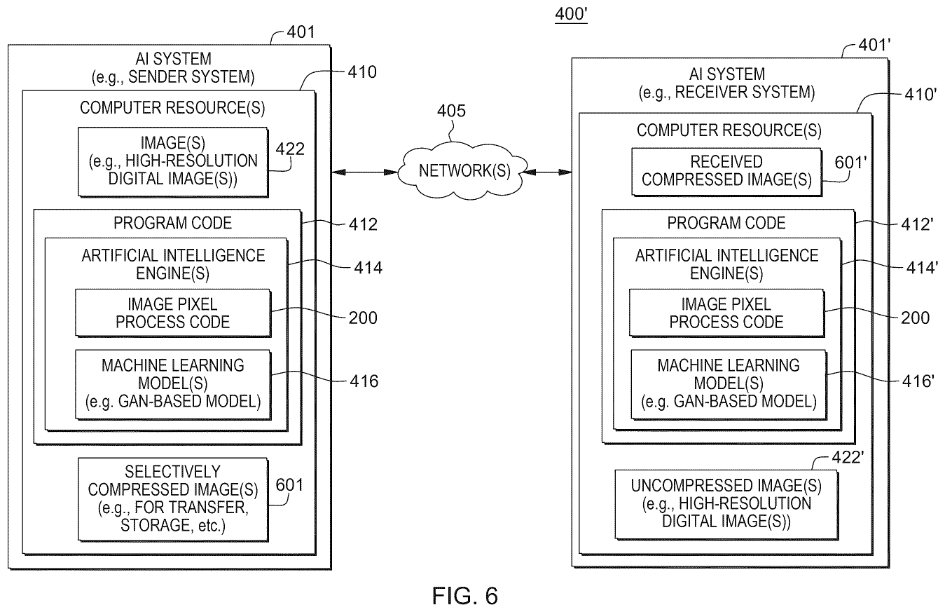

As noted, executing of the GAN-based model includes generating a predicted pixel based on surrounding pixels of the masked pixel in a process window iteration over the image, and selecting the predicted pixel as a valid proxy pixel where a similarity comparison of the predicted pixel to a corresponding original pixel exceeds a pixel content similarity threshold. Further, executing the GAN-based model includes selectively compressing the image to produce a selectively compressed image, where the selectively compressing includes masking, at least in part, the selected pixels of the image in producing the selectively compressed image, where the selectively compressed image can be uncompressed, at least in part, by reconstructing the predicted pixels for the selected pixels of the image. In one or more embodiments, the AI system 401 executing, for instance, image pixel process code 200, provides the selectively compressed image by, for instance, initiating transmission of the selectively compressed image to a receiver (e.g., receiver system, receiver device, receiver component, etc.) of the computing environment 400. In particular, AI system 401 can provide (or receive) one or more selectively compressed images and/or provide (or receive) one or more other actions 430 to (or from), for instance, a receiver system, including, transferring the selectively compressed image from the AI system as sender to a receiver system, such as a receiver AI system, as in the example of FIG. 6. Similarly, at the receiver system, the image pixel process code 200 can be used to uncompress the compressed image and reconstruct the image, as described herein. Other solutions/recommendations/actions 430 can also be provided by AI system 401, such as taking further actions on the selectively compressed image, or the uncompressed, reconstructed image, including, for instance, further processing the image, saving the image, displaying the image, etc.

In one or more implementations, computing environment 400 can include, or utilize, one or more internal and/or external networks 405 for interfacing various aspects of computer resource(s) 410, data source(s) 420, as well as one of or more other controllers, components, systems, etc., receiving an action, compressed image, uncompressed image, etc., 430 of the image pixel process code 200, and/or artificial intelligence system 401, in a manner that facilitates the improved computer-based system processing disclosed herein. By way of example, the network(s) can be, for instance, a telecommunications network, a local area network (LAN), a wide area network (WAN), such as the Internet, or a combination thereof, and can include wired, wireless, fiber optic connections, etc. The network(s) can include one or more wired and/or wireless networks that are capable of receiving and/or transmitting electronic image data, including (for instance) training data for one or more of the machine learning model(s) of, or used by, the artificial intelligence system such as disclosed herein, and an output solution, recommendation, or action of the image pixel process code 200, and/or artificial intelligence system 401, such discussed herein.

In one or more implementations, computer resource(s) 410 house and/or execute program code 412 configured to perform computer-implemented methods in accordance with one or more aspects of the present disclosure. By way of example, computer resource(s) 410 can be a computing-system-implemented resource(s). Further, for illustrative purposes only, computer resource(s) 410 in FIG. 4 is depicted as being a single computer resource. This is a non-limiting example of an implementation. In one or more other embodiments, computer resource(s) 410, which implements one or more aspects of processing such as discussed herein, can, at least in part, be implemented in multiple separate computer resources or systems, such as one or more computer resources of a cloud-hosting environment, by way of example.

Briefly described, in one embodiment, computer resource(s) 410 can include one or more processor sets with one or more processors, for instance, central processing units (CPUs). Also, the processor set(s) can include functional components used in the integration of program code, such as functional components to fetch program code from locations in memory, such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the image pixel process code processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computer resource(s), or computing system(s) or controller(s), which can implement one or more aspects disclosed are described further herein.

In one or more embodiments, program code 412 includes, executes, accesses, etc., artificial intelligence engine 414, with image pixel process code 200, which can train and/or use machine learning models 416 that embody (in part), or are used by, the image pixel process code 200. The artificial intelligence engine 414 can be (in part) one or more artificial intelligence (AI) agents or AI tools and/or can include, or use, one or more machine learning models that are pretrained using training data that can include a variety of types of electronic image data. In one or more embodiments, program code 412 executing on one or more computer resources 410 applies one or more algorithms of, for instance, the artificial intelligence engine 414 to generate and train the machine learning model(s) 416, which the program code then utilizes to, for instance, implement one or more aspects of image pixel process code 200. In an initialization or learning stage, program code 412 can train the one or more machine learning models 416 using an obtained training dataset to implement, for instance, one or more aspects of the code, functions and/or tools described herein.

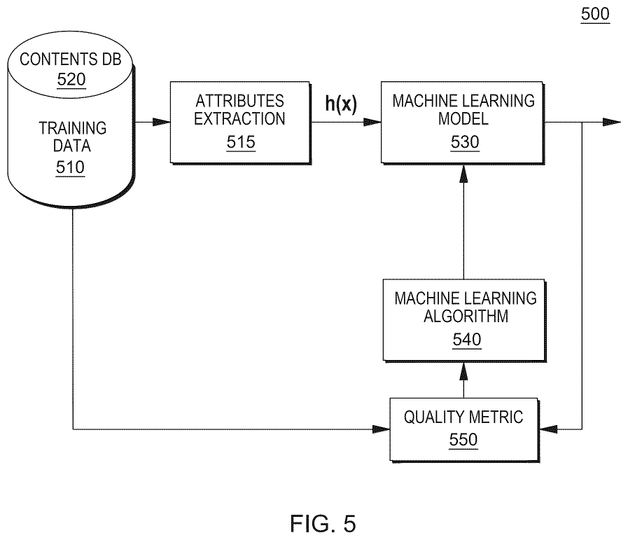

One example of a machine learning training system is depicted in FIG. 5. In one or more embodiments, a machine learning training system 500 can be utilized to perform cognitive analysis of various inputs, including input image data, such as image data from one or more sources, repositories, and/or other image data, such as described herein. Program code, in embodiments of the present disclosure, can perform data analysis to generate data structures, including algorithms utilized by the program code to implement one or more aspects of the image pixel process and/or initiate (or perform) an action related thereto. As known, machine learning-based modeling solves problems that cannot be solved by numerical means alone. In one example, program code extracts features/attributes 515 from the training data 510, which can be stored in memory or one or more databases 520. The extracted features can be utilized to develop a predictor function, h(x), also referred to as a hypothesis, which the program code utilizes as a model 530.

In identifying various event states, features, attribute similarities, constraints and/or behaviors indicative of states in the ML training data 510, the program code can utilize various techniques to identify attributes in an embodiment of the present disclosure. Embodiments of the present disclosure utilize varying techniques to select attributes (data attributes, elements, patterns, features, constraints, distribution, etc.), including but not limited to, diffusion mapping, principal component analysis, recursive feature elimination (a brute force approach to selecting attributes), and/or a Random Forest, to select the attributes related to various events. The program code may utilize a machine learning algorithm 540 to train the machine learning model(s) 530 (e.g., the algorithms utilized by the program code), including providing weights for the conclusions, so that the program code can train the predictor functions that comprise the machine learning model(s) 530. The conclusions may be evaluated by a quality metric 550. By selecting a diverse set of ML training data 510, the program code trains the machine learning model(s) 530 to identify and weight various attributes (e.g., data attributes, features, patterns, constraints, distributions, etc.) that correlate to various states or events of a process.

The model generated by the program code can be self-learning, since in one or more embodiments, the program code can update the model based on feedback data, such as from, or based on, obtained results of the pixel prediction-based, selective compression process. For example, when the program code determines that there is a constraint, event, similarity or pattern (e.g., data attribute, record attribute similarity, query pattern, data distribution, search terms distribution, etc.) that was not previously predicted by the model, the program code can utilize a learning agent to update the model to reflect the state of the event, in order to improve predictions in the future. Additionally, when the program code determines that a prediction is incorrect, either based on receiving user feedback through an interface or based on monitoring results of the image pixel processing, the program code can update the model to reflect the inaccuracy of the model results. Program code including a learning agent cognitively analyzes any data deviating from the modeled expectations and adjusts the model to increase the accuracy of the model, moving forward.

In one or more embodiments, the program code can utilize one or more neural networks (NNs) to, for instance, analyze training data and/or collected data to generate an operational machine learning model. Neural networks are a programming paradigm which enables a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a machine learning model, such as described herein.

Generative adversarial networks are recent innovations in machine learning and represent an approach towards generative modeling using deep learning methods, such as convolutional neural networks. Generative adversarial networks present a way of training a generative model by framing a problem as a supervised learning problem with two sub-models: a generator model that is trained to generate new examples, and a discriminator model that tries to classify examples as either real (from the domain) or fake (generated by the system). The two models are trained together in a zero-sum game, adversarial, until the discriminator model is fooled about half the time, meaning that the generator model is generating plausible examples. As disclosed herein, GAN-based modeling is used, in one or more embodiments, to facilitate compressing and decompressing images, such as high-resolution images, including video images.

As background, the work “pixel” means a picture element. Every image, in digital form, is made up of pixels. They are the smallest unit of information that makes up the picture. Typically, round or square pixels are arranged in a two-dimensional grid. The pixels are provided to approximate the actual image. The more pixels, the more closely the digital image resembles the original domain. The number of pixels in an image is referred to as the resolution. When using the term to describe pixel count, one convention is to express resolution as the width by the height, for example, a monitor resolution of 1280×1024. This means there are 1280 pixels from one side to the other, and 1024 pixels from top to bottom. Another convention is to express the number of pixels as a single number, such as a 5 megapixel camera (where megapixel is one million pixels). This means that the number of pixels along the width multiplied by the number of pixels along the height of the image taken by the camera equals 5 million pixels. In the case of a 1280×1024 monitor, it could also be expressed as a 1.31 megapixels monitor.

As discussed herein, image pixel prediction is a process where neighboring pixel intensities or properties are taken into consideration in predicting, for instance, a missing or masked pixel's intensity. As disclosed, pixel prediction can have a wide range of real-life applications, as in image or video coding, image compression and reversible data hiding, all of which require that the error between the predicted pixel and the original pixel be as low as possible.

In embodiments, given a large-sized media file (e.g., containing one or more images, one or more video clips, etc.) that needs to be transmitted from a sender to a receiver via a network, such as the Internet, a considerable amount of time can traditionally be required to upload the image at the sender and download the image at the receiver to obtain the transmitted image data. The amount of time required depends on the size of the image file. Note that, many existing media compression techniques do not assist with reconstructing an original file at the receiver with the same information and as good a quality as the original source image file. Traditionally, the more image data compression, the more possibility of losing information and quality during the reconstruction process.

Advantageously, disclosed herein are methods, computer program products, and computer systems, which include program code implementing, accessing, using, etc., one or more trained generative adversarial network (GAN)-based machine learning models, which when executed on, or over, an image (e.g., a digital image, video file, media file, etc.) selects pixels of the image with valid proxy pixels (generated by the GAN-based model) to facilitate enhanced image compression. In one or more embodiments, executing the GAN-based model includes, for a masked pixel of the image, generating a predicted pixel based on surrounding pixels of the masked pixel in a process window iteration over the image, and selecting the predicted pixel as a valid proxy pixel where a similarity comparison of the predicted pixel to the corresponding original pixel exceeds the pixel similarity threshold. Further, the method includes selectively compressing the image to produce a selectively compressed image, with the selectively compressing including masking, at least in part, the selected pixels of the image in producing the selectively compressed image, where the selectively compressed image can be uncompressed, at least in part, by reconstructing the predicted pixels for the selected pixels of the image. Advantageously, the GAN-based model approach disclosed herein enhances realistic generation of pixels at the receiver by ensuring reconstructing of the masked selected pixels at a desired, high similarity level. As such, content of the masked selected pixels need not be transmitted from the sender to the receiver, but rather, the pixels are readily regenerated at the receiver using, for instance, one or more aspects of the GAN-based model processing disclosed. The processing presented herein optimizes, in one or more embodiments, the image compression/decompressing and transmission processes and can reduce transmission costs significantly.

As another example, FIG. 6 depicts an embodiment of a computing environment 400′, which can incorporate, use, or implement, one or more aspects of the present disclosure. In one or more embodiments, computing environment 400′ includes and/or is similar to computing environment 400 described above in connection with FIG. 4. As noted in connection with FIG. 4, computing environment 400′ can be implemented as part of, or include, a computing environment such as computing environment 100 described above in connection with FIG. 1. In one or more implementations, computing environment 400′ includes an artificial intelligence (AI) system 401, such as a sender system, and an AI system 401′, such as a receiver system, which are operatively coupled in communication across one or more networks 405. In one or more embodiments, AI system 401′ is the same as, or similar to AI system 401 described above in connection with FIG. 4. Further, in one or more embodiments, AI system 401 and AI system 401′ include respective computer resources 410, 410′ such as one or more computers 101 of FIG. 1, operatively connected across one or more networks 405 to transmit and receive data including, for instance, one or more compressed images, such as disclosed herein.

In the embodiment of FIG. 6, AI system 401 includes, or obtains, one or more images 422, such as one or more high-resolution digital images to undergo pixel prediction-based, selective compression, as disclosed herein. In embodiments, computer resources 410, 410′ of AI systems 401, 401′ execute respective program code 412, 412′ that runs or implements, for instance, one or more artificial intelligence engines 414, 414′ that execute or include one or more aspects of image pixel process code 200, and/or image pixel processing 300 (FIG. 3), such as disclosed herein. In one or more embodiments, image pixel process code 200 includes, utilizes and/or trains one or more machine learning models 416, 416′ which can be part of image pixel process code 200 or accessed by image pixel process code 200. In one or more embodiments, machine learning models 416, 416′ include, for instance, one or more GAN-based models which are configured or trained to facilitate pixel prediction-based, selective compression, as disclosed herein.

As illustrated in FIG. 6, in one or more embodiments, AI system 401 executes the trained GAN-based model, such as disclosed herein, on (or over) one or more images to select pixels of the one or more images with valid proxy pixels (generated by the GAN-based model) to facilitate image compression. As noted, executing the GAN-based model on the image includes, for a masked pixel of the image, generating a predicted pixel based on surrounding pixels of the masked pixel in a process window iteration over the image, and selecting the predicted pixel as a valid proxy pixel where a similarity comparison of the predicted pixel to the corresponding original pixel exceeds a pixel content similarity threshold. Further, the method includes selectively compressing the image to produce a selectively compressed image 601, the selectively compressing includes masking, at least in part, the selected pixels of the image in producing the selectively compressed image. Advantageously, the received selectively compressed image 601′ can then be uncompressed, at least in part, by reconstructing the predicted pixels for the selected pixels of the image.

In one or more embodiments, AI system 401 executes the image pixel process code 200 to produce, for instance, one or more compressed images 601 (e.g., for transfer, storage, etc.), where compressed images 601 can be, or be derived, using the selectively compressed image(s). In embodiments, one or more compressed images 601 of AI system 401 are transmitted via one or more networks 405 to AI system 401′, with the received compressed image(s) 601′ to undergo reverse GAN-based model processing, such as disclosed herein. For instance, in one or more embodiments, AI system 401′, with image pixel process code 200 executing on computer resources 410′, uncompresses the received compressed image(s) 601′, including reconstructing the predicted pixels for the masked, selected pixels of the image to obtain the desired high-resolution digital image 422′, such as for display or further processing at AI system 401′. In particular, in one or more embodiments, the trained GAN-based model 416′ is accessed by, or implemented at, AI system 401′ (e.g., receiver system) to reconstruct the respective, predicted pixels as part of the decompression process, where the reconstruction is, in one embodiment, in a reverse (or backward) direction over the image to the original image processing direction at the sender system (e.g., AI system 401). The reverse direction processing at the receiver system is desirable since later masked pixels can be needed or helpful in reconstructing prior masked pixels. Advantageously, in one or more embodiments, the original high-resolution image can be more accurately generated or regenerated at the receiver system by selectively compressing at the sender only the pixels that can be regenerated with high accuracy based on the GAN-based model. The selective compression of the best predicted pixels leads to better transmission and reconstruction processing, which reduces processing overhead and costs, and provides a better result.

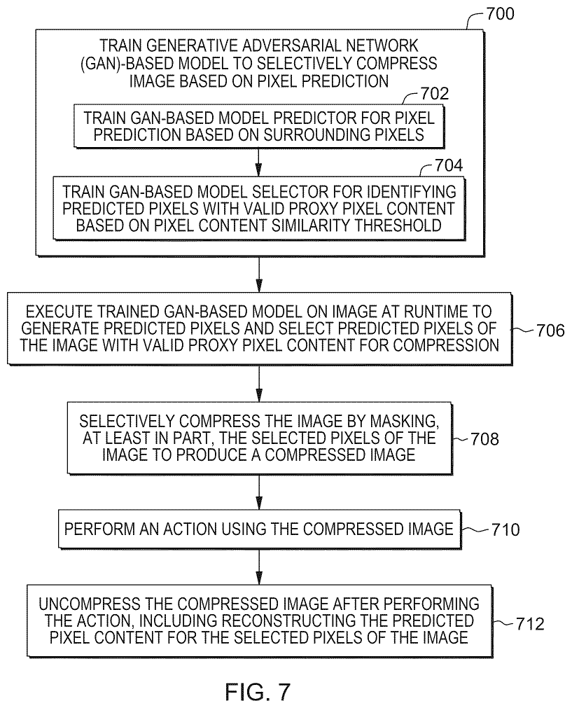

FIG. 7 depicts another embodiment of an image pixel process workflow, in accordance with one or more aspects of the present disclosure. In one or more embodiments, the image pixel process workflow of FIG. 7 is the same or similar, at least in part, to the above-described image pixel process workflows, such as the workflows of FIGS. 3A-3B. In one or more embodiments, image pixel process workflow includes, as discussed above in connection with FIGS. 2A-6, training a generative adversarial network (GAN)-based model 700, which further includes, in one or more embodiments, training a predictor of the GAN-based model to perform pixel prediction based on surrounding pixels 702, as well as training a selector of the GAN-based model to identify a predicted pixel as a valid proxy pixel based on a similarity comparison of the predicted pixel content to the original pixel content exceeding a pixel content similarity threshold 704.

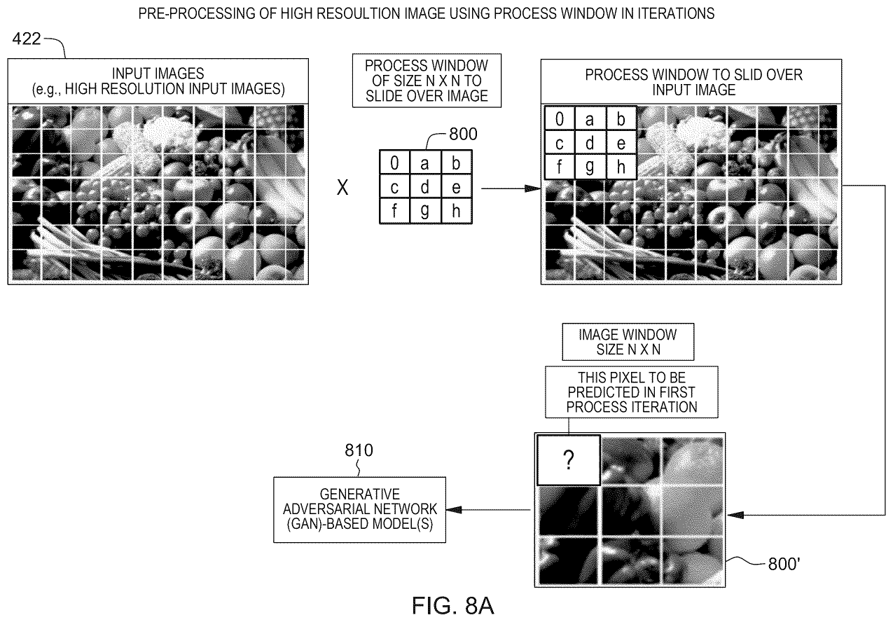

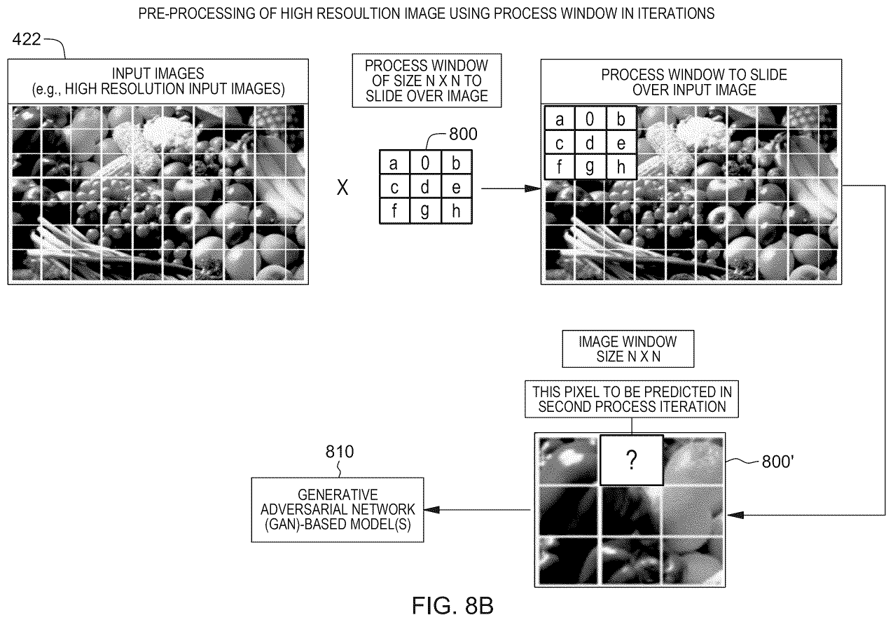

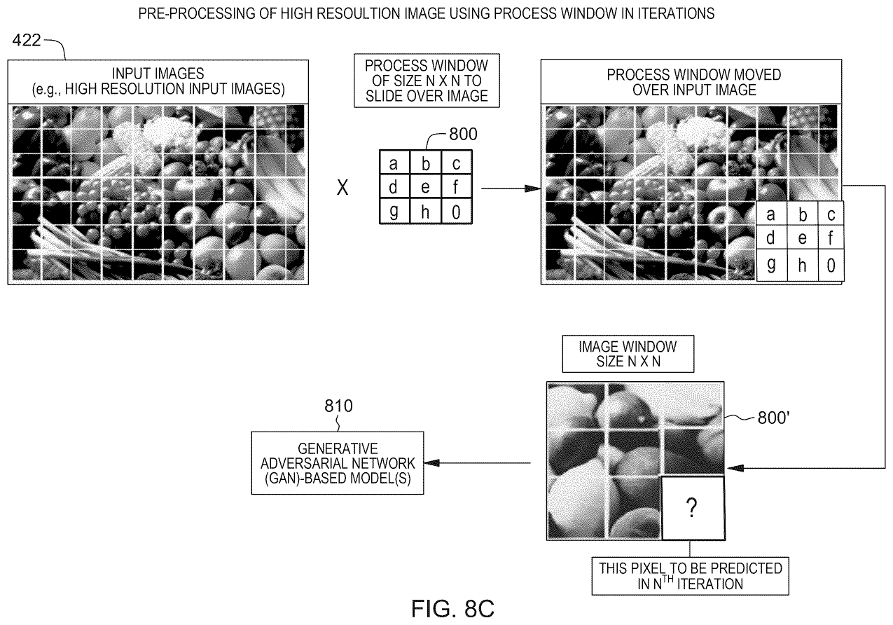

In embodiments, the GAN-based model is trained, in part, to provide a pixel content prediction based on content of the surrounding pixels, and the input to the model is, one or more embodiments, a given image or window of an image, which needs to be compressed for, for instance, transfer to a receiver, such as a receiver system. For example, in one or more embodiments, the input to the GAN-based model is a given high-resolution image which needs to be compressed and transmitted to a receiver with enhanced reconstruction quality at the receiver than prior approaches. The image is initially pre-processed before passing the image to the GAN-based model for training. A process window (e.g., kernel, filter, sliding window, etc.) of size N×N is defined, which is slid over the input window of the image in a specified direction, such as a specified forward direction. An example of this is depicted in FIG. 8A, where a process window 800 is overlayed on an input image 422 (or input image window), with a slide value (or window slide value) also being defined for moving (or stepping) the process window across the image so that pixels can be skipped or included during the slide process, as desired for a particular application. In the example of FIG. 8A, process window 800 is overlayed onto image 422 in an upper left corner of the image as an initial starting point and as processing progresses, the process window is slid across the image to focus training of the GAN-based model on different pixels of the image. During processing, a different pixel in each process window iteration is masked or hidden so that the GAN-based model is trained to predict the masked (or missing) pixel, and the process iterations continue for the particular process window location, and the processing continues to repeat as the process window is stepped across the image. Note that the number of pixels used for prediction by the GAN-based model can be learned by the artificial intelligence system as a hyper parameter. The process window 800′, with the masked pixel and the surrounding pixels, is supplied to the one or more GAN-based models 810.

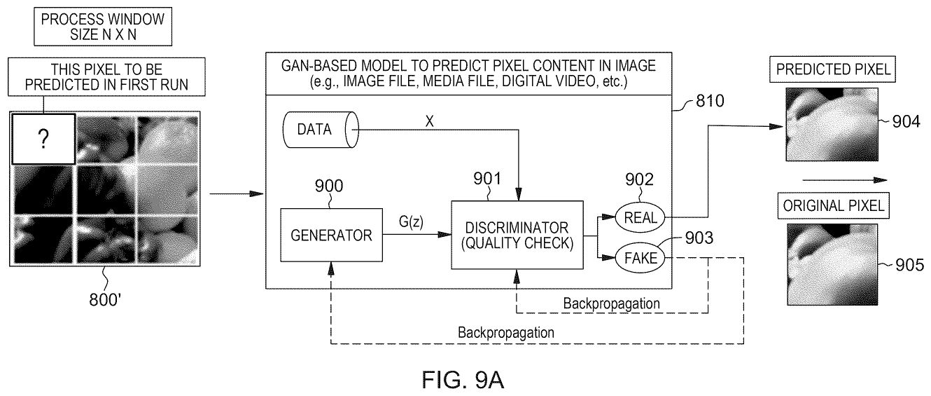

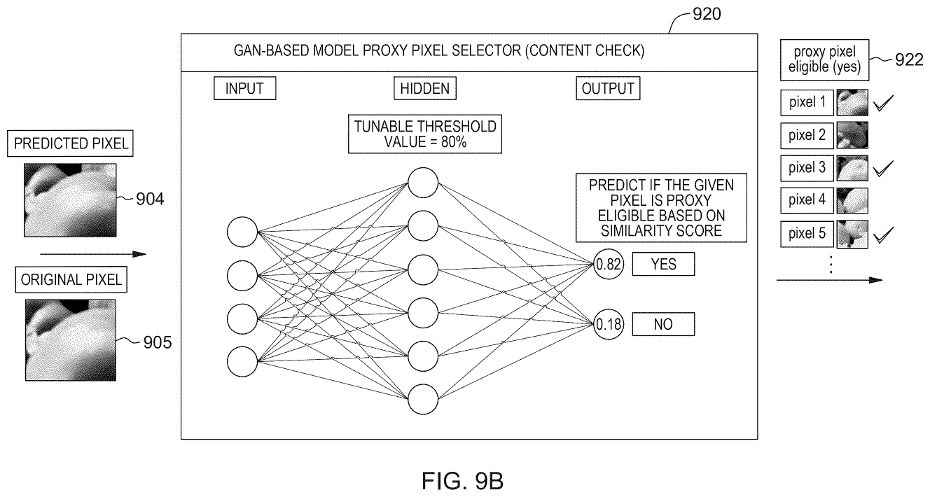

As depicted in FIG. 9A, GAN-based model 810 includes, in one or more embodiments, a generator 900, which in one or more embodiments, is a network that learns to create synthetic or predicted pixels for a masked pixel based on the surrounding pixels within the process window 800′. In addition, GAN-based model 810 includes a discriminator 901, or discriminator network, that is trained to distinguish between real data, or valid proxy pixel data, and the fake, or synthetic data generated by generator 900. The generator 900 does the task of pixel prediction based on the surrounding pixel data, and the discriminator does the task of finding if the predicted pixel (i.e., the generator) is real or fake in terms of quality, and back propagates the calculated loss. As illustrated in FIGS. 8B & 8C, the process continues for different masked pixels across the process window iterations (FIG. 8B) as well as for different process window locations, where the process window is stepped or slid across the image, as represented by the example of FIG. 8C. In one or more embodiments, each pixel within the process window can be separately masked and the process repeated across multiple cycles or iterations until substantially all pixels of the digital image have been processed through the GAN-based model, as one example only.

As noted, training the generative adversarial network-based model further includes training a selector of, or associated with, the GAN-based model to identify a predicted pixel as a valid proxy pixel based on similarity comparison to the original pixel data. As illustrated in FIGS. 9A & 9B, a predicted pixel 904 (e.g., generated based on the surrounding pixels of a masked pixel in the process window iteration 800′ by the GAN-based model) is compared to the original pixel 905 by a similarity-based selector or selector network 920. In one or more embodiments, the selector, or classifier module, is imbedded in the GAN-based model, and compares the predicted pixel 904 at a particular process iteration to the corresponding original pixel, that is, to the corresponding unmasked content of the pixel. In one or more embodiments, a tunable threshold parameter, or pixel content similarity threshold, is predefined as part of the GAN-based model for the selector 902. The selector decides whether the predicted pixel 904 is a valid proxy pixel by determining that a similarity comparison between the predicted pixel 904 and the corresponding original pixel 905 exceeds the pixel content similarity threshold. An example of this is depicted in FIG. 9B, where, for instance, a similarity comparison of 0.82 is determined by the selector 920 to exceed a pixel content similarity threshold set at 80%, as one example only. Note that the selector is trained to determined if the predicted pixel for a particular masked pixel is proxy eligible based on the similarity score comparison. Note also that, the pixel content similarity score for a particular comparison means, that at any timestep, where the GAN-based model predicts the masked pixel (i.e., generator predicted pixel or real pixel) of the image to have less loss value, and be more similar to the original pixel, then the pixel content similarity score is determined to be higher. Further, at any timestep where the GAN-based model is unable to predict the masked pixel of the input image, that is, if it has more loss value and is less similar to the original pixel, then in that case, the pixel content similarity score is determined to be lower. Where the pixel content similarity score exceeds the pixel content similarity threshold value, then the given predicted pixel is eligible to be compressed or selectively masked, as disclosed herein, and the predicted pixel is flagged or selected as “proxy pixel: Yes”. Where the pixel content similarity score falls below the pixel content similarity threshold, then the predicted pixel is not considered to be a valid proxy pixel, and the pixel is flagged as “proxy pixel: No”. In one or more embodiments, the process repeats for each pixel of the process window 800′ at different locations over the image as the process window is slid or stepped over the image. In the example of FIG. 9B, three of the five pixels in the example are designated as “proxy pixel: Yes” 922, by way of example. After the full process of training the GAN-based model selector with multiple images, the best reconstructed pixels are selected or identified overall for a particular image, and marked as “proxy pixel: Yes”. In one or more embodiments, the “proxy pixel: Yes” are the selected pixels which can be selectively compressed, such as for subsequent validation and testing of the GAN-based model, and/or during runtime use of the model to facilitate transmission of an image from a sender to a receiver, such as disclosed.

As illustrated in FIG. 7, in one or more embodiments, the image pixel process workflow further includes executing the trained GAN-based model on an image at runtime to generate predicted pixels and select predicted pixels of the image with valid proxy pixel content for compression 706. As noted, in one or more embodiments, executing the trained GAN-based model on an image to select pixels of the image with valid proxy pixels being generated by the GAN-based model to facilitate image compression includes, for a masked pixel of the image, executing the GAN-based model to generate a predicted pixel based on surrounding pixels of the masked pixel in a process window iteration of the image. As noted, the generating proceeds for a plurality (or all) of the pixels across the image to identify the selected pixels to be selectively compressed. In one or more implementations, the image is, for instance, a digital image that is passed through the GAN-based model, which identifies pixels of the image (e.g., a high-resolution digital image, video image, etc.) as “proxy pixel: Yes”, and compresses or masked only those selected pixels. Identifying a predicted pixel as a valid proxy pixel occurs where a similarity comparison of the predicted pixel to the corresponding original pixel exceeds the pixel content similarity threshold predefined for the selector of the GAN-based model.

As depicted in FIG. 7, in one or more embodiments, the image pixel process further includes selectively compressing the image by masking, at least in part, the selected pixels of the image in producing a compressed image 708. In particular, in one or more embodiments, the selected pixels marked “proxy pixel: Yes” are partially compressed by, for instance, masking those pixels to produce the selectively compressed image. In one or more embodiments, the masking of the selected pixels can include blocking as compressed latent data the selected pixels of the image in producing the selectively compressed image. In another embodiment, masking, at least in part, the selected pixels of the image can include substituting a default value for each of the selected pixels in producing the selectively compressed image. The masking results in a partial compression of the image data, with the masking being based on the ability to reconstruct selected pixels of the image with high quality (e.g., close to the original pixel data), which is contrasted with a fully compress process or randomly compress process as with many existing compression techniques, and which can reduce image reconstruction overhead compared with existing approaches. In one or more embodiments, one or more actions are performed using the selectively compressed image 710, such as further encoding and transmission to a receiver system, saving of the selectively compressed image to a database, etc. Advantageously, the GAN-based model processing disclosed results in partial and intelligent selective compressing of pixels, which can enhance transmission speed and overhead, and/or enhance data storage overhead, as well as provide better quality of images during the reconstruction process. As illustrated in FIG. 7, in one or more embodiments, the workflow further includes uncompressing the compressed image after performing the action, including reconstructing the predicted pixel content for the selected pixels of the image 712. For instance, where the compressed image is transmitted from a sender to a receiver, the received, compressed image is uncompressed at the receiver, including reconstructing the predicted pixels for the selectively masked pixels of the image. In one or more embodiments, the reconstructing uses a trained GAN-based model to generate the predicted pixels for the selectively masked pixels in reverse direction (e.g., backward process direction on the image) compared with the direction of GAN-based model processing, for instance, at the sender. The desirability of backward or reverse processing at the receiver assumes that later selected pixels are generally used to reconstruct earlier selected pixels in the process. Advantageously, the original, high-resolution image can be regenerated by selectively compressing only those predicted pixels which can be regenerated with a high similarity to the original pixel data, that is, with pixel content similarity scores above the defined pixel content similarity threshold.

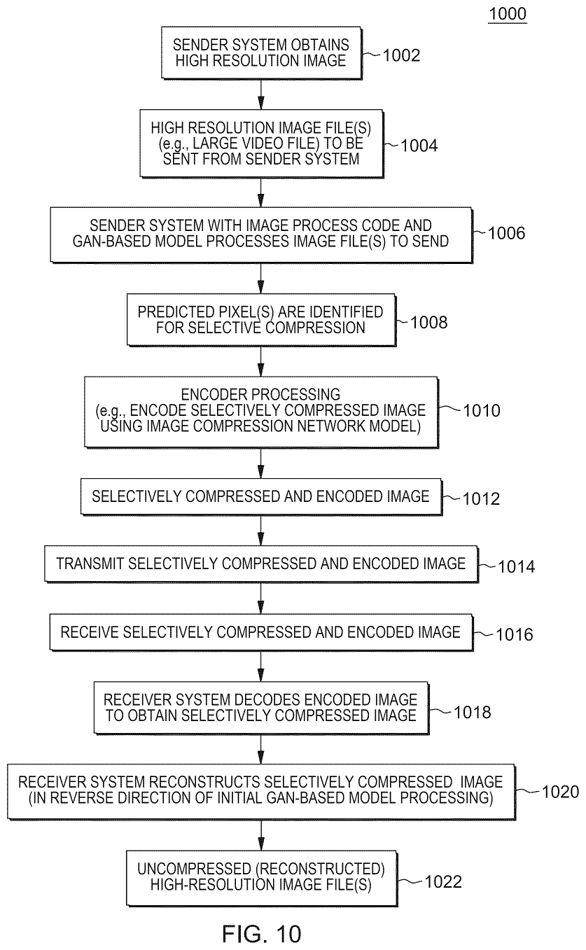

FIG. 10 depicts another embodiment of an image pixel process 1000 representative of an exemplary process using the trained generative adversarial network (GAN)-based model disclosed herein. Those skilled in the art will note that, in one or more embodiments, the image pixel process workflow 1000 of FIG. 10 is the same or similar, at least in part, to the above-described image pixel process workflows of FIGS. 3A-3 & 7-9B. As illustrated in FIG. 10, in one embodiment, image pixel process 1000 includes obtaining by a sender system one or more images, such as one or more high-resolution digital images, that are to be sent from the sender system to a receiver system 1002. In one or more embodiments, the one or more images can be, or can be part of, for instance, one or more video files or media files to be sent from the sender system across one or more networks to a receiver system 1004. The sender system, such as an artificial intelligence (AI) sender system, such as discussed above in connection with FIG. 6, includes image pixel process code and GAN-based models, such as disclosed herein 1006. As described, in one or more embodiments, the sender system executes the trained GAN-based model on the image to select pixels of the image with valid proxy pixels being generated by the GAN-based model to facilitate image compression and decompression. In one or more embodiments, the executing includes, for a masked pixel of the image, generating a predicted pixel based on surrounding pixels of the masked pixel, and selecting the predicted pixel as a valid proxy pixel where the similarity comparison of the predicted pixel to a corresponding original pixel exceeds a pixel content similarity threshold. The image is selectively compressed to produce a selectively compressed image 1008 including, for instance, masking, at least in part, the selected pixels of the image to produce the selectively compressed image, where the selectively compressed image can be uncompressed, at least in part, by reconstructing the predicted pixels for the selected pixels of the image.

In one or more embodiments, the selectively compressed image can be further encoded, for instance, for network transmission 1010, with the encoded image being based, in one embodiment, on the selectively compressed or masked pixels of the image to produce a selectively compressed and encoded image 1012. Advantageously, the selective compressing disclosed reduces the size of the image file, which saves bandwidth during processing, storage and transmission. In one or more embodiments, further encoding of the selectively compressed image can be performed, for instance, to facilitate standardization of data transmission and/or security of the data transmission. The selectively compressed and encoded image is transmitted 1014 to a receiver system, which receives the compressed and encoded image 1016. In one or more embodiments, the receiver system is an artificial intelligence-based receiver system which decodes the encoded image to re-obtain the selectively compressed image 1018. After decoding the encoded image, the receiver system reconstructs the selectively compressed image by reconstructing the selected pixels as predicted pixels, for instance, in a reverse direction of GAN-based model processing for the reconstruction process as used in the initial selective compression process by the sender system 1020. The reconstruction provides the uncompressed or reconstructed image, such as a reconstructed high-resolution image, which can then be further processed, displayed, stored, etc., as desired for a particular application 1022.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method comprising:
executing a trained generative adversarial network (GAN)-based model on an image to select pixels of the image with valid proxy pixels being generated by the GAN-based model to facilitate image compression, where for a masked pixel of the image, executing the GAN-based model:
generates a predicted pixel based on surrounding pixels of the masked pixel in a process window iteration over the image; and
selects the predicted pixel as a valid proxy pixel where a similarity comparison of the predicted pixel to a corresponding original pixel exceeds a pixel content similarity threshold; and
selectively compressing the image to produce a selectively compressed image, the selectively compressing including masking, at least in part, the selected pixels of the image in producing the selectively compressed image, where the selectively compressed image can be uncompressed, at least in part, by reconstructing the predicted pixels for the selected pixels of the image.

2. The method of claim 1, wherein the masking, at least in part, the selected pixels of the image comprises blocking as compressed latent data the selected pixels of the image in producing the selectively compressed image.

3. The method of claim 1, wherein the masking, at least in part, the selected pixels of the image comprises substituting a default value for each of the selected pixels in producing the selectively compressed image.

4. The method of claim 1, wherein the selectively compressing the image comprises masking, at least in part, only the selected pixels of the image in producing the selectively compressed image.

5. The method of claim 1, wherein during executing the GAN-based model on the image, a pixel of the image within the process window iteration is masked to generate the masked pixel.

6. The method of claim 1, wherein executing the GAN-based model on the image further comprises selecting, based on image content, a window size of multiple window sizes for the process window used in generating, for the masked pixel of the image, the predicted pixel based on the surrounding pixels of the image in the process window.

7. The method of claim 1, wherein executing the GAN-based model on the image includes iteratively moving the process window across the image at a predefined stride in a specified direction in generating, for different masked pixels of the image, the selected pixels of the image with predicted pixels selected as valid proxy pixels.

8. The method of claim 1, wherein the pixel content similarity threshold is predefined in the GAN-based model.

9. The method of claim 1, wherein the selecting comprises identifying predicted pixels of the image with higher pixel content similarity scores relative to other predicted pixels of the image.

10. A computer program product comprising:
one or more computer-readable program storage media; and
program instructions stored on the one or more computer-readable storage media to perform operations comprising:
executing a trained generative adversarial network (GAN)-based model on an image to select pixels of the image with valid proxy pixels being generated by the GAN-based model to facilitate image compression, where for a masked pixel of the image, executing the GAN-based model:
generates a predicted pixel based on surrounding pixels of the masked pixel in a process window iteration over the image; and
selects the predicted pixel as a valid proxy pixel where a similarity comparison of the predicted pixel to a corresponding original pixel exceeds a pixel content similarity threshold; and
selectively compressing the image to produce a selectively compressed image, the selectively compressing including masking, at least in part, the selected pixels of the image in producing the selectively compressed image, where the selectively compressed image can be uncompressed, at least in part, by reconstructing the predicted pixels for the selected pixels of the image.

11. The computer program product of claim 10, wherein the masking, at least in part, the selected pixels of the image comprises blocking as compressed latent data the selected pixels of the image in producing the selectively compressed image.

12. The computer program product of claim 10, wherein the masking, at least in part, the selected pixels of the image comprises substituting a default value for each of the selected pixels in producing the selectively compressed image.

13. The computer program product of claim 10, wherein the selectively compressing the image comprises masking, at least in part, only the selected pixels of the image in producing the selectively compressed image.

14. The computer program product of claim 10, wherein during executing the GAN-based model on the image, a pixel of the image within the process window iteration is masked to generate the masked pixel.

15. The computer program product of claim 10, wherein executing the GAN-based model on the image further comprises selecting, based on image content, a window size of multiple window sizes for the process window used in generating, for the masked pixel of the image, the predicted pixel based on the surrounding pixels of the image in the process window.

16. The computer program product of claim 10, wherein executing the GAN-based model on the image includes iteratively moving the process window across the image at a predefined stride in a specified direction in generating, for different masked pixels of the image, the selected pixels of the image with predicted pixels selected as valid proxy pixels.

17. A computer system comprising:
a processor set;
one or more computer-readable storage media; and
program instructions stored on the one or more computer-readable storage media to cause a processor set to perform operations comprising:
executing a trained generative adversarial network (GAN)-based model on an image to select pixels of the image with valid proxy pixels being generated by the GAN-based model to facilitate image compression, where for a masked pixel of the image, executing the GAN-based model:
generates a predicted pixel based on surrounding pixels of the masked pixel in a process window iteration over the image; and
selects the predicted pixel as a valid proxy pixel where a similarity comparison of the predicted pixel to a corresponding original pixel exceeds a pixel content similarity threshold; and
selectively compressing the image to produce a selectively compressed image, the selectively compressing including masking, at least in part, the selected pixels of the image in producing the selectively compressed image, where the selectively compressed image can be uncompressed, at least in part, by reconstructing the predicted pixels for the selected pixels of the image.

18. The computer system of claim 17, wherein the masking, at least in part, the selected pixels of the image comprises blocking as compressed latent data the selected pixels of the image in producing the selectively compressed image.

19. The computer system of claim 17, wherein the masking, at least in part, the selected pixels of the image comprises substituting a default value for each of the selected pixels in producing the selectively compressed image.

20. The computer system of claim 17, wherein the selectively compressing the image comprises masking, at least in part, only the selected pixels of the image in producing the selectively compressed image.
